(19) United States
(12) Patent Application Publication
(10) Pub. No.: US 2009/0195920 A1
(43) Pub. Date: Aug. 6, 2009

(54) Main pole bridge structure

(76) Inventors: Christian R. Bonhote, San Jose, CA (US); Jeffrey S. Lille, Sunnyvale, CA (US); Vladimir Nikitin, Campbell, CA (US); Aron Pentek, San Jose, CA (US)

Correspondence Address: HITACHI C/O WAGNER BLECHER LLP, 123 WESTRIDGE DRIVE, WATSONVILLE, CA, 95076, US

(21) Appl. No.: 12/012,364

(22) Filed: Jan. 31, 2008

(51) Int. Cl. G11B 33/14

(52) U.S. Cl. 360/97.02

(57) ABSTRACT

A method of reducing flux leakage between a main pole and a wrap around shield (WAS) is provided. A gap underneath a main pole is etched. Magnetic material is deposited in the gap. A layer of nonmagnetic material is deposited on the magnetic material, wherein the layer of nonmagnetic material reduces flux leakage between the main pole and the WAS.

### TECHNICAL FIELD

The field of the present invention relates generally to perpendicular magnetic recording write heads, and more particularly to an etched gap of a main pole for use in magnetic recording hard disk drives.

### BACKGROUND ART

Direct access storage devices (DASD) have become part of every day life, and as such, expectations and demands continually increase for better performance at lower cost. To meet these demands, the mechano-electrical assembly in a DASD device, specifically the Hard Disk Drive (HDD) has evolved to meet these demands.

In order for an HDD to hold more data, advances in the disk media in which the data is written as well as the magnetic transducer for writing and reading the data have undergone major advances in the past few years.

The magnetic transducer used in the first hard disk drives was based on an inductive principle for both writing and reading data to and from the disk media. For writing data into the disk media, electric current is passed through an electrically conductive coil, which is wrapped around a ferromagnetic core. The electric current passing through the write coil induces a magnetic field in the core, which magnetizes a pattern of localized spots in the disk media as the disk media passes close to the magnetic transducer. The pattern of magnetized spots in the media forms data that can be read and manipulated by the HDD.

Conventional magnetic recording technology used in HDDs is currently facing limitations due to thermal instabilities in the longitudinal magnetic media. Consequently, perpendicular recording is being considered as a viable alternative to longitudinal recording. Perpendicular recording is capable of deferring the (superparamagnetic) density limit beyond what is achievable with longitudinal recording. Thus, continuing advances are being made in write pole design and fabrication methods as more demands are made on the performance of HDDs using perpendicular recording.

### SUMMARY OF EMBODIMENTS OF THE INVENTION

A method of reducing flux leakage between a main pole and a wrap around shield (WAS) is provided. A gap between a substrate and a main pole is etched. Magnetic material is deposited in the gap. A layer of nonmagnetic material is deposited on the magnetic material, wherein the layer of nonmagnetic material reduces flux leakage between the main pole and the WAS.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a schematic, top plane view of a hard disk drive that can use main pole bridge structures, in accordance with one embodiment of the invention.

FIG. 2 is an illustration of a top view of an example main pole of a write head upon a substrate, in accordance with one embodiment of the present invention.

FIG. 3 is an illustration of a side view of an example main pole bridge structure, in accordance with one embodiment of the present invention.

FIG. 4 is an illustration of a top view of an example main pole of a write head upon a substrate, including magnetic material and nonmagnetic material, in accordance with one embodiment of the present invention.

FIG. 5 is an illustration of a cross-sectional view of an example main pole neck with surrounding nonmagnetic material, in accordance with one embodiment of the present invention.

FIG. 6 is a flow diagram of an example method 600 for reducing flux leakage between a main pole and a wrap around shield, in accordance with one embodiment of the present invention.

### DETAILED DESCRIPTION

Reference will now be made in detail to embodiments of the present technology. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following detailed description, numerous specific details are set forth in order to provide a thorough understanding of the present technology. However, it will be recognized by one of ordinary skill in the art that the present technology may be practiced without these specific details. In other instances, well known methods, procedures, components, and have not-been described in detail as not to unnecessarily obscure aspects of the present embodiments.

The discussion will begin with an overview of a hard disk drive and components connected within. The discussion will then focus on embodiments of the invention that provide a main pole bridge structure for reducing magnetic flux leakage between a main pole and a wrap around shield (WAS). The discussion will also focus on embodiments of the invention that provide a method of reducing magnetic flux leakage between a main pole and the WAS.

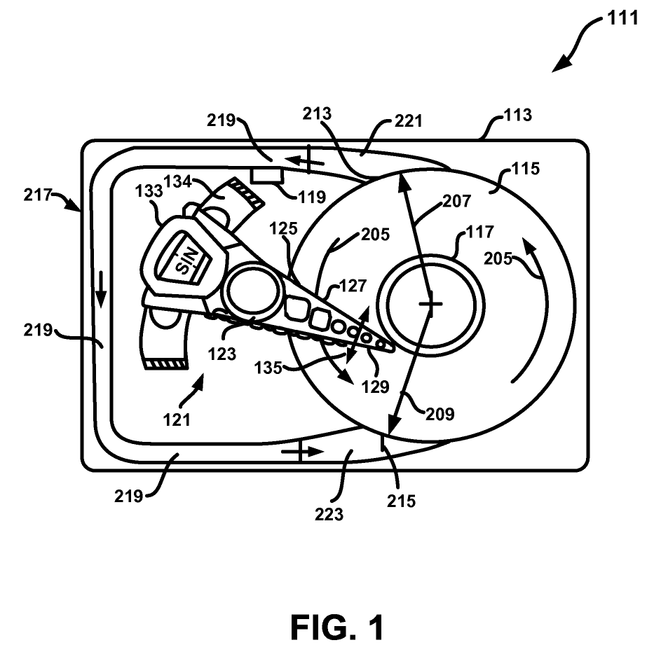

With reference now to FIG. 1, a schematic drawing of one embodiment of an information storage system comprising a magnetic hard disk file or drive 111 for a computer system is shown. Drive 111 has an outer housing or base 113 containing a disk pack having at least one media or magnetic disk 115. A spindle motor assembly having a central drive hub 117 rotates the disk or disks 115.

An actuator 121 comprises a plurality of parallel actuator arms 125 (one shown) in the form of a comb that is movably or pivotally mounted to base 113 about a pivot assembly 123. A controller 119 is also mounted to base 113 for selectively moving the comb of arms 125 relative to disk 115.

In the embodiment shown, each arm 125 has extending from it at least one cantilevered electrical lead suspension (ELS) 127 (load beam removed). It should be understood that ELS 127 may be, in one embodiment, an integrated lead suspension (ILS) that is formed by a subtractive process.

In another embodiment, ELS 127 may be formed by an additive process, such as a Circuit Integrated Suspension (CIS). In yet another embodiment, ELS 127 may be a Flex-On Suspension (FOS) attached to base metal or it may be a Flex Gimbal Suspension Assembly (FGSA) that is attached to a base metal layer.

The ELS may be any form of lead suspension that can be used in a Data Access Storage Device, such as a HDD. A magnetic read/write transducer or head is mounted on a slider 129 and secured to a flexure that is flexibly mounted to each ELS 127. The read/write heads magnetically read data from and/or magnetically write data to disk 115. The level of integration called the head gimbal assembly is the head and the slider 129, which are mounted on suspension 127. The slider 129 is usually bonded to the end of ELS 127.

ELS 127 has a spring-like quality, which biases or presses the air-bearing surface of the slider 129 against the disk 115 to cause the slider 129 to fly at a precise distance from the disk. The ELS 127 has a hinge area that provides for the spring-like quality, and a flexing interconnect that supports read and write traces through the hinge area. A voice coil 133, free to move within a conventional voice coil motor magnet assembly 134 (top pole not shown), is also mounted to arms 125 opposite the head gimbal assemblies.

Movement of the actuator 121 (indicated by arrow 135) by controller 119 causes the head gimbal assemblies to move along radial arcs across tracks on the disk 115 until the heads settle on their set target tracks. The head gimbal assemblies operate in a conventional manner and move in unison with one another, unless drive 111 uses multiple independent actuators (not shown) wherein the arms can move independently of one another.

Perpendicular magnetic recording technology used in HDDs include ever changing innovative features. In particular, the write pole design and fabrication methods seek to increase the flux carrying capacity of the main write pole while reducing and/or eliminating flux leakage between the write's main pole and the wrap around shield (WAS). Embodiments of the present invention achieve this goal by providing additional magnetic material surrounding the main pole, thus increasing the main pole's flux carrying capacity. Additionally, a method of fully enveloping the main pole with nonmagnetic material is provided, thus reducing flux leakage, as well as achieving a self-aligned flare point and throat height condition.

More specifically, a gap is etched between the main pole and the substrate upon which it rests during the fabrication process. For example, an etchant recesses the substrate's floor directly underneath the main pole, and also undercuts the main pole. A main pole bridge structure is formed through this etching process. Then, magnetic material is deposited into this gap. This magnetic material acts as a conduit for magnetic flux, thus increasing the main pole's magnetic flux carrying capacity. The main pole is now almost completely surrounded by magnetic material. Only the area connected to the main pole and containing the thin alumina mask (TAM) remains without magnetic material plated upon it.

Nonmagnetic material is then deposited on all of the magnetic material and on the TAM, thereby completely surrounding the main pole. It is appreciated that deposit may mean any act which serves to connect the two materials, such as by plating. The nonmagnetic material acts to reduce and/or eliminate the transfer of magnetic flux between the main pole and the wrap around shield (WAS).

The WAS is located on the border of the nonmagnetic material, and completely circumscribes the main pole. In one embodiment, a WAS may be extended to fully enclose the main pole by utilizing the etched gap to extend, build, and/or connect a shield from one side of the gap to a shield at the other side of the gap. By wrapping a WAS fully around the main pole, the WAS serves to increase the sharp write gradient by more effectively directing magnetic flux at a disk.

Thus, embodiments of the present invention utilize the etched gap to add magnetic material, nonmagnetic material, more WAS, and to acquire a self-aligned throat height and flare point. Ultimately, the present invention increases the magnetic flux bearing capacity while decreasing magnetic flux leakage.

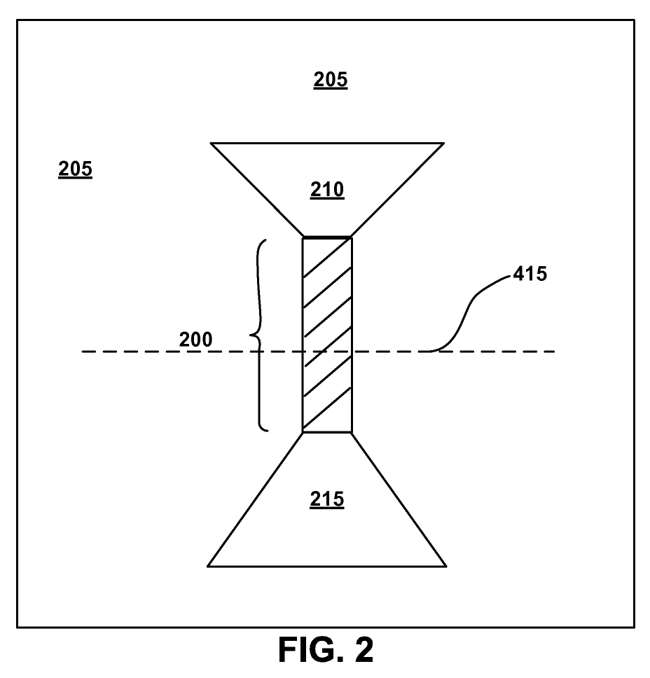

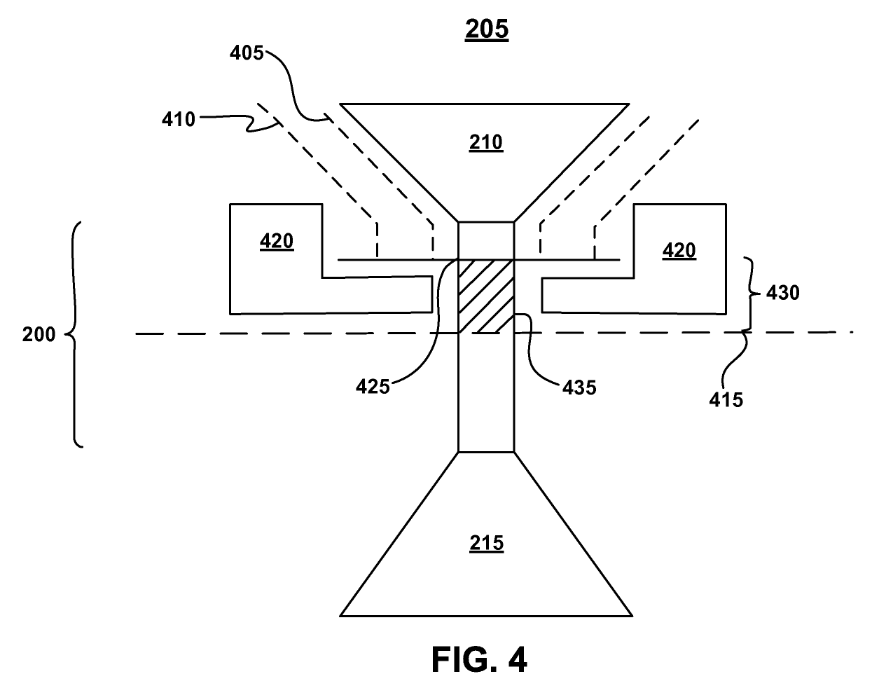

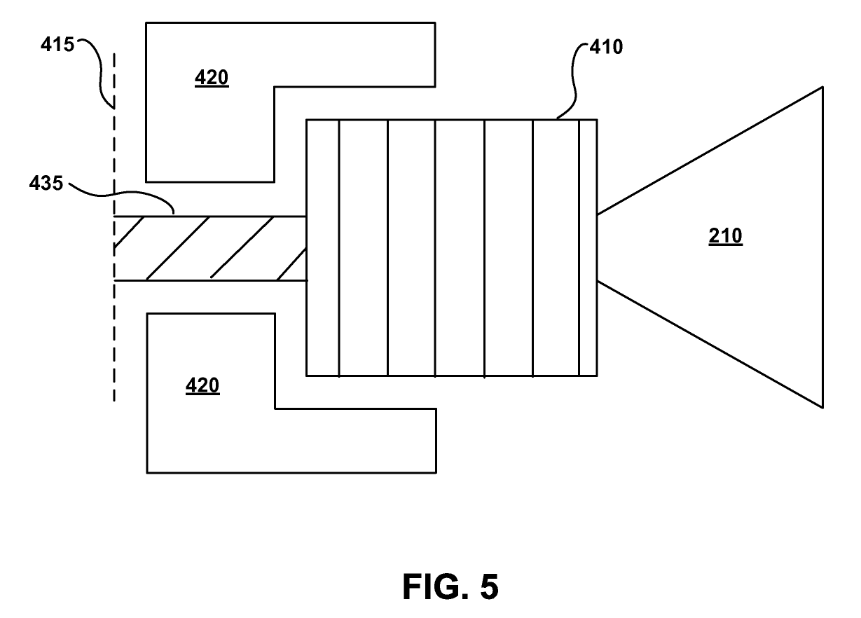

FIG. 2 is an illustration of a top view of an example main pole portion 200 of a write head upon substrate 205 according to one embodiment of the present invention. In one embodiment, substrate 205 is a wafer. As shown, main pole portion 200 is connected with yoke 210 and anchor 215. During fabrication of the present invention, main pole portion 200 is sliced in half, leaving two pieces. One piece comprises yoke 210 and main pole portion 200. Another piece comprises anchor 215 and main pole portion 200. Additionally, one side of main pole portion 200 rests upon substrate 205 during the manufacturing process and is thus unavailable to be plated with various materials. For purposes of adding perspective, it is noted that the future air bearing surface (ABS) 415 plane runs horizontally through main pole portion 200 and ABS 415 is shown in FIGS. 4 and 5.

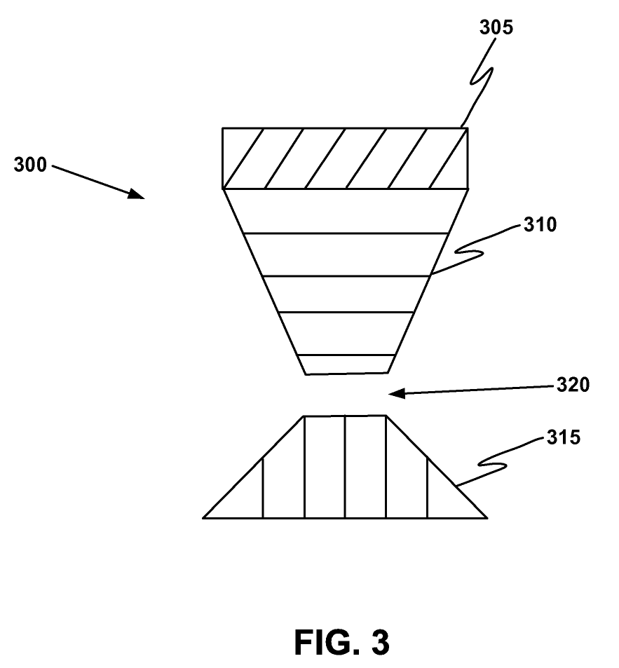

However, embodiments of the present invention provide for an etched gap between substrate 205 and main pole portion 200. A gap is etched by utilizing an etchant to recess the floor of substrate 205 and to undercut main pole portion 200. Magnetic materials may be deposited in the resulting gap and then plated over with nonmagnetic materials. FIG. 3 is an illustration of a side view of a main pole bridge structure 300, according to one embodiment of the present invention. Main pole bridge structure 300 includes the following: surface of the main pole portion 305, body of the main pole portion 310, and pedestal of the main pole portion 315. Pedestal of main pole portion 315 is that point at which main pole portion 200 rests upon substrate 205. Between body of main pole portion 310 and pedestal of main pole portion 315 is gap 320. Gap 320 has been etched out utilizing various techniques, thereby exposing a leading edge of main pole portion 200. Magnetic materials which are deposited into gap 320, are then plated over with nonmagnetic materials.

Referring now to 400 of FIG. 4, an illustration of a top view of an example main pole portion 200 of a write head upon substrate 205, including magnetic material 405 and nonmagnetic material 410, is shown according to one embodiment of the present invention. FIG. 4 shows main pole portion 200, yoke 210, magnetic material 405, nonmagnetic material 410, air bearing surface 415, plate shield 420, flare point 425, throat height 430, and photo-resist 435.

In one embodiment, magnetic material 405 is CoFe. In another embodiment, magnetic material 405 may be NiFe. Magnetic material 405 is plated onto main pole portion 200 using standard plating techniques known in the art. Magnetic material 405 aids in the conduction of magnetic flux through main pole portion 200. However, the area of main pole portion 200 which has the thin alumina mask (TAM) is not plated with magnetic material 405. Additionally, the side of main pole portion 200 which rests upon substrate 205 is inaccessible for plating during its fabrication process. Therefore, this side of main pole portion 200 does not contain any plated magnetic material 405.

However, embodiments of the present invention provide for etched gap 320, wherein the floor of substrate 205 is recessed and a bottom portion of main pole portion 200 is undercut. Magnetic material 405 may be deposited in etched gap 320. Thus, once deposited, magnetic material 405 surrounds main pole portion 200 (except for the portion covered by the thin alumina mask (TAM)) and increases the magnetic flux through main pole portion 200. Gap 320 may be etched out utilizing, but not limited to, the following etchants: an Al or Al₂O₃ etchant, a tetramethyl ammonium hydroxide (TMAH) etchant, a deep ultraviolet (DUV) etchant, a potassium hydroxide etchant, a sodium hydroxide etchant, and/or an etchant with a pH>10. It is appreciated that etchants other than chemical ones may be utilized in creating gap 320.

Furthermore, in one embodiment, a layer of photo-resist 435 is placed on main pole portion 200 between ABS 415 and a pre-determined location on main pole portion 200. Magnetic material 405 and nonmagnetic material 410 may not be plated onto areas containing photo-resist 435. Thus, the area designated as photo-resist 435 in FIG. 4 does not contain plated material. A defined edge is then created between the portion of main pole portion 200 which does not have plated material, and the area above photo-resist 435 containing plated magnetic material 405 and nonmagnetic material 410. Thus, a layer of nonmagnetic material 410 is plated in alignment with the defined edge of photo-resist 435 on main pole portion 200.

However, even though depositing magnetic material 405 into gap 320 increases magnetic flux in main pole portion 200, magnetic flux leakage also increased between main pole portion 200 and WAS 420. For example, magnetic flux jumps from main pole portion 200 to WAS 420. Even though WAS 420 protects main pole portion 200 from stray magnetic fields, WAS 420 robs main pole portion 200 of magnetic flux. WAS 420 wraps around all sides of main pole 200, except for the side of main pole portion 200 which lies upon substrate 205.

The presence of nonmagnetic material 410 plated on magnetic material 405 serves to decrease flux leakage. The layer of nonmagnetic material 410 serves to block magnetic flux from jumping from main pole portion 200 to WAS 420, thus reducing magnetic flux leakage during write head operation. By etching out gap 320 in the main pole portion 200, in one embodiment, a layer of nonmagnetic material 410 may be plated onto magnetic material 405 which was deposited into gap 320.

Thus, main pole portion 200 is completely surrounded by a layer of magnetic material 405 (except for the TAM portion), which increases its magnetic flux carrying capacity, and a layer of nonmagnetic material 410 (including TAM portion), which decreases magnetic flux leakage to WAS 420. Also, it is appreciated that the leading edge of main pole portion 200 is plated with magnetic material 405 in alignment with the edges of the plating of magnetic material 405 on each other side of main pole portion 200.

Furthermore, in one embodiment, the measurable thickness of the nonmagnetic material 410 plated onto the side of main pole portion 200 is greater than the measurable thickness of nonmagnetic material 410 plated onto the top of main pole portion 200 (on top of the TAM). Thus, the side to top thickness ratio of nonmagnetic material 410 surrounding main pole portion 200 is greater than one, and forms a bump of nonmagnetic material 410.

In one embodiment, nonmagnetic material 410 is NiP. Furthermore, nonmagnetic material 410 is plated onto magnetic material 405 using standard plating techniques known in the art. Additionally, in one embodiment, the area within gap 320 also provides for WAS 420 to be wrapped fully around main pole portion 200. By having a fully wrapped WAS 420, the write gradient of main pole portion 200 improves, thus improving magnetic flux delivery from main pole portion 200 to a disk.

FIG. 4 also shows flare point 425 and throat height 430. A flare point is the location at the intersection of the main pole portion 200 with yoke 210, where the yoke flares outward. In FIG. 4, flare point 425 is the point at which magnetic material 405 and nonmagnetic material 410 abruptly stop (due to the presence of a layer of photo-resist 435). This is the point at which the flux carrying capacity increases due to the addition of magnetic material 405. It also corresponds to the point at which a part of main pole portion 200 widens significantly, and the edge of a layer of photo-resist 435 exists. Flare point 425 is measured in association with its distance away from ABS 415, and in terms of comparing flare point 425 with throat height 430.

Throat height 430 is the length from ABS 415 to an edge of an insulating film which electrically insulates a thin film coil for magnetic flux generation. In one embodiment, flare point 425 and throat height 430 are equal, and as such, are self-aligned.

In one embodiment, photo-resist 435 is removed and replaced with a thin layer of insulating material. Then WAS 420 is placed in the space between ABS 415 and flare point 425. Thus, in one embodiment, flare point 425 and throat height 430 are self-aligned, in that the distance of flare point 425 from ABS 415 equals throat height 430.

Referring now to FIG. 5, an illustration of a cross-sectional view of main pole portion 200 with surrounding nonmagnetic material 410 is shown, in accordance with one embodiment. FIG. 5 includes main pole portion 200, nonmagnetic material 410, yoke 210, and WAS 420. As can be seen, nonmagnetic material 410 completely surrounds main pole neck 200. WAS 420 also may partially or completely surround main pole portion 200.

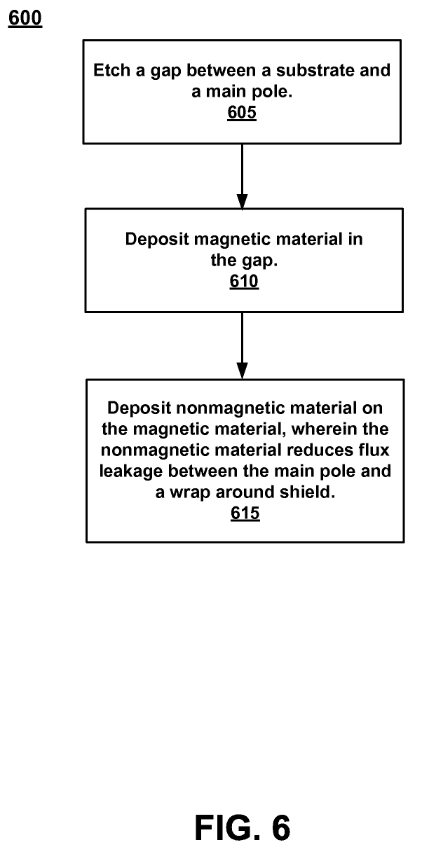

Referring now to FIG. 6, a flow diagram of an example method 600 of reducing flux leakage between main pole portion 200 and WAS 420 is shown in accordance with one embodiment of the present invention.

Referring to 605 of FIG. 6 and as described herein, gap 320 is etched between substrate 205 and main pole portion 200. Gap 320 is formed by utilizing an etchant to recess the floor of substrate 205, and undercut main pole portion 200. Referring to 610 of FIG. 6, magnetic material 405 is deposited in gap 320. Referring to 615 of FIG. 6, nonmagnetic material 410 is then deposited on magnetic material 405, wherein nonmagnetic material 410 reduces flux leakage between main pole portion 200 and WAS 420.

In one embodiment, a leading edge of main pole portion 200 is exposed, through chemical etching. The following is, but is not limited to, a list of etchants which may be utilized to expose the leading edge: a weak Al₂O₃ etchant, a tetramethyl ammonium hydroxide (TMAH) etchant; and a deep ultraviolet (DUV) etchant.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

I claim:

1. A method of reducing flux leakage between a main pole and a wrap around shield (WAS), said method comprising:
etching a gap between a substrate and a main pole;
depositing magnetic material in said gap;
depositing nonmagnetic material on said magnetic material, wherein said nonmagnetic material reduces flux leakage between said main pole and a WAS.

2. The method of claim 1, wherein said etching a gap underneath a main pole further comprises:
exposing a leading edge of said main pole by chemical etching.

3. The method of claim 1, further comprising:
utilizing an Al₂O₃ etchant.

4. The method of claim 1, further comprising:
utilizing a tetramethyl ammonium hydroxide (TMAH) etchant.

5. The method of claim 2, further comprising:
utilizing a deep ultraviolet (DUV) etchant.

6. The method of claim 1, further comprising:
wrapping said WAS fully around said main pole.

7. The method of claim 1, further comprising:
plating a leading edge of said main pole with said magnetic material in alignment with defined plating of each other side of said main pole.

8. The method of claim 1, further comprising:
plating said layer of nonmagnetic material in alignment with a defined edge of photo-resist on said main pole.

9. The method of claim 1, further comprising:
providing a side to top thickness ratio of said nonmagnetic material that is greater than one.

10. A main pole bridge structure comprising:
a main pole on a substrate;
an gap between said substrate and said main pole, said gap configured to receive a layer of nonmagnetic material plated on a layer of magnetic material, wherein said layer of nonmagnetic material reduces flux leakage between said main pole and a wrap around shield (WAS).

11. The main pole bridge structure of claim 10 wherein said main pole further comprises:
an exposed leading edge configured to be plated with said magnetic material.

12. The main pole bridge structure of claim 11, further comprising:
a plating of said magnetic material on said exposed leading edge in alignment with a plating on each other side of said main pole.

13. The main pole bridge structure of claim 10, wherein said nonmagnetic material forms a nonmagnetic bump on said main pole.

14. The main pole bridge structure of claim 12, wherein said nonmagnetic bump of said main pole is aligned with a defined edge of a photo-resist of said main pole.

15. The main pole bridge structure of claim 10, further comprising:
a side to top thickness ratio of said nonmagnetic material of greater than one.

16. A hard disk drive comprising:
a housing;
at least one disk mounted to the housing and rotatable relative to the housing;
an actuator mounted to said housing and being movable relative to said at least one disk, said actuator having a suspension for reaching over said at least one disk, said suspension having a slider coupled therewith, said slider having a read/write head element; and
a main pole bridge structure for reducing flux leakage from between a main pole bridge and a wrap around shield, said main pole bridge structure comprises:
a main pole;
a layer of magnetic material deposited in an undercut portion of said main pole;
a layer of nonmagnetic material deposited on said layer of magnetic material, said layer of nonmagnetic material for reducing flux leakage between said main pole and a wrap around shield.

17. The main pole bridge structure of claim 16, further comprising:
an exposed leading edge configured to be plated with said magnetic material.

18. The main pole bridge structure of claim 16, further comprising:
a nonmagnetic bump on said main pole formed from said nonmagnetic material.

19. The main pole bridge structure of claim 18, wherein said nonmagnetic bump of said main pole is aligned with a defined edge of a photo-resist of said main pole.

20. The main pole bridge structure of claim 16, further comprising:
a side to top thickness ratio of said nonmagnetic material of greater than one.
